(19) United States
(12) Patent Application Publication
(10) Pub. No.: US 2005/0168772 A1
(43) Pub. Date: Aug. 4, 2005

(54) Network printing system using messenger and method thereof

(75) Inventor: Joo-duck Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/016,908

(22) Filed: Dec. 21, 2004

(30) Foreign Application Priority Data
Jan. 29, 2004 (JP) 2004-5862

(51) Int. Cl. G06F 15/00; G06F 3/12

(52) U.S. Cl. 358/1.15

(57) ABSTRACT

A network printing system and method is disclosed. The network printing system comprises an information device linked to a network, for transmitting and receiving messages with an external device through the network, a chat server providing a messenger to the information device to transmit and receive messages between the information device and the external device through the messenger, and a printer linked to the network, for performing a print job with respect to a file which is requested printing by the information device. The chat server receives the print-requested file from the information device through the messenger and transmits the file to the printer. Accordingly, since the information device which has no printer driver installed therein can perform a print job through the network printer, the utilization of a mobile terminal is maximized.

### CROSS REFERENCE TO RELATED APPLICATIONS

This application claims the benefit under 35 U.S.C. § 119(a) of Korean Patent Application No. 2004-5862, filed on Jan. 29, 2004, in the Korean Intellectual Property Office, the entire contents of which is incorporated herein by reference.

### BACKGROUND OF THE INVENTION

1. Field of the Invention

The present invention relates to a network printing system and a method thereof. More particularly, the present invention relates to a network printing system with an information device which has no printer driver installed therein and a method thereof.

2. Description of the Related Art

A printer is a well-known office machine that is connected to a computer and outputs a printed document. Specifically, the printer receives documents or image data created or edited by the computer as print data, translates the print data into a print language which is appropriate for setting printing conditions, and outputs the data on the paper using a colored dye such as ink or toner.

Existing printers are often networked so that several users can share the printer. Accordingly, work efficiency in the office can be improved. A system having the networked printer is referred to as a network printing system.

In a typical network printing system, one printer is connected to a plurality of computers through a Local Area Network (LAN). The printer in the network printing system receives print data from the plurality of computers through the LAN to perform print jobs. Since the network printing system enables several users to share one printer, it can realize cost-savings via office automation.

FIG. 1 is a block diagram illustrating a conventional network printing system. Referring to FIG. 1, the network printing system comprises a network printer 110 for performing print jobs with respect to received print data, computers 120 which request the network printer 100 perform the printing jobs, and a network 130 for connecting the network printer 110 to the computers.

Both the network printer 110 and computers 120 are core and requisite devices to achieve office automation, and in order to print documents created by the computers 120 through the network printer 110, the computer 120 must have a printer driver to drive the network printer 100.

The printer driver has the functionality to translate print data created by an application of the computer 120 into data that is compatible with the network printer 110. That is, when a print command is selected to output the documents created by the application of the computer 120 through the network printer 110, the printer driver divides print data page by page, properly processes certain data and control codes which are contained in the print data corresponding to one page, translates the print data into data that is compatible with the network printer 110, and transmits the translated data to the network printer 110. The printer driver also provides a print information selection display that allows a user to select print information about the document to be printed, for example the range of pages to be printed, the number of sheets to be printed, printing method, and paper cassette.

The network printer 110, which prints the print data received from the printer driver according to the print information, has a paper cassette which stacks therein an image recording medium such as paper. The network printer 110 picks-up and transfers the paper from the paper cassette, forms an image on the paper by using toner at an image forming part, and discharges the paper.

As described above, the general network printing system requires a program such as the printer driver in order for the computer 120 to communicate with the network printer 110. If the network printing system has no printer driver installed therein, the data created and edited by the computer 120 cannot be printed through the network printer 110.

### SUMMARY OF THE INVENTION

The present invention has been developed in order to solve the above problems in the related art. Accordingly, an aspect of the present invention is to provide a network printing system capable of printing a job through a network printer without requiring a printer driver installed therein, and a method thereof.

The above aspect is achieved by providing a network printing system comprising an information device linked to a network, for transmitting and receiving messages with an external device through the network, a chat server for providing a messenger to the information device to transmit and receive messages between the information device and the external device through the messenger, and a printer linked to the network, for performing a print job with respect to a file which is requested for printing by the information device. The chat server receives the print-requested file from the information device through the messenger and transmits the file to the printer.

The network printing system may further comprise a conversion server for converting the print-requested file into a Page Description Language (PDL) data. If the print-requested file is not compatible with the printer, the printer prints the PDL data converted by the conversion server.

The information device may comprise a transceiver, an application part for driving the messenger provided from the chat server, and a storage part for storing the print-requested file. The transceiver transmits the file stored in the storage unit to the chat server through the messenger driven by the application part.

The chat server may comprise a command parser for analyzing a print command executed by the information device, and a command executor for controlling at least one of the printer and the conversion part according to the print command analyzed by the command parser.

A network printing method comprises the steps of providing a messenger to an information device linked through a network via a chat server, receiving a file requested for printing by the information device through the messenger, and printing the received file via a printer.

The network printing method may further comprise the steps of determining an ability to print the received file via the printer, and converting the file into a PDL data via a conversion server if the file is not determined to be compatible with the printer. The printer prints the PDL data converted by the converting step.

The network printing method may further comprise the step of searching an application with respect to the file received through the conversion server. The converting step converts the file into the PDL data made compatible with the application searched by the searching step.

The network printing method may further comprise the steps of storing the file for printing via the information device, and driving the messenger provided from the chat server. The information device transmits the stored file to the chat server through the messenger.

The network printing method may further comprise the steps of analyzing a print command executed by the information device via the chat server, and controlling at least one of the printer and the conversion server according to the analyzed print command.

Accordingly, the information device having no printer driver and application can print through the network printer.

### BRIEF DESCRIPTION OF THE DRAWINGS

The above aspect and other advantages of the present invention will be more apparent by describing an embodiment of the present invention with reference to the accompanying drawings, in which:

FIG. 1 is a block diagram illustrating a general network printing system;

FIG. 2 is a block diagram illustrating a network printing system according to an embodiment of the present invention;

FIG. 3 is a flowchart illustrating a printing method of the network printing system of FIG. 2;

FIG. 4 is a diagram illustrating an example of print commands input through the information device of FIG. 2; and

FIG. 5 is a diagram illustrating an another example of print commands input through the information device of FIG. 2.

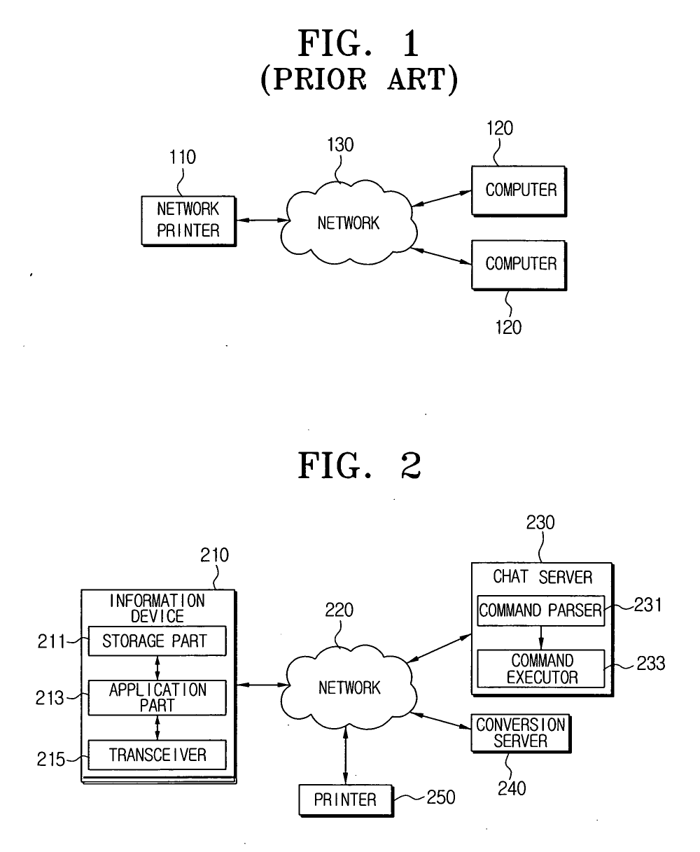

Throughout the drawings, it should be noted that the same or similar elements are denoted by like reference numerals.

### DETAILED DESCRIPTION OF THE EXEMPLARY EMBODIMENTS

FIG. 2 is a block diagram illustrating a network printing system according to an embodiment of the present invention. Referring to FIG. 2, the network printing system comprises an information device 210, a network 220, a chat server 230, a conversion server 240, and a printer 250. The information device 210, the chat server 230, the conversion server 240 and the printer 150 are linked to one another through the network 220.

The information device 210 is linked to the network 220 to transmit and receive messages with an external device through the network 220. The information device 210 comprises a Personal Digital Assistant (PDA), a mobile phone, a laptop computer, and a personal computer, which are devices with the ability to access the network 220 in a wired or a wireless manner and are capable of transmitting and receiving data through the network 220. The “external device” in this embodiment should be understood as being a general term that encompasses other information devices, the chat server 230, the conversion server 240 and the printer 250.

The information device 210 comprises a storage part 211, an application part 213, and a transceiver 215. The storage part 211 stores a printing file. The application part 213 drives a messenger provided from the chat server 230. The transceiver 215 transmits the file stored in the storage part 211 to the chat server 230 through the messenger driven by the application part 230.

The chat server 230 comprises a command parser 231 and a command executor 233. The command parser 231 analyzes print commands with respect to the printing file executed by the information device 210. The command executor 233 controls the conversion server 240 and the printer 250 according to the print command analyzed by the command parser 231.

The conversion server 240 converts the printing file, which is requested by the information device 210, into Page Description Language (PDL) data. The PDL data is a language for describing contents of one printed page, which is typically used to control laser printers printing the contents of one page one page at a time.

The printer 250 is linked to the network 220 and performs a print job with respect to the file which is requested for printing by the information device 210.

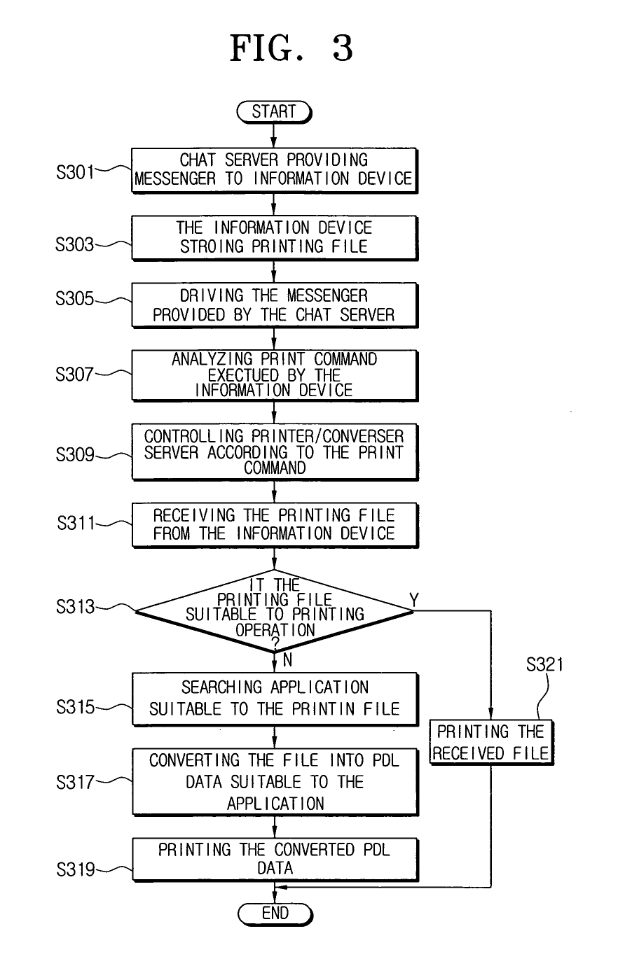

FIG. 3 is a flowchart illustrating a printing method of the network printing system of FIG. 2. With reference to FIG. 3, operations of the network printing system according to an embodiment of the present invention are described in detail.

The chat server 230 provides the messenger to the information device 210 linked through the network 220 at step of S301. The information device 210 transmits and receives messages with external devices through the messenger received from the chat server 230.

The information device 210 creates a printing file with contents of dialogue transceived with the external device (i.e., dialogue transmitted to and received from the external device) or with documents created by other external device such as a computer or a laptop computer, and stores the file at step of S303.

The application part 213 of the information device 210 drives the messenger at step of S305 to transmit and receive text messages with the external devices. In order to print the printing file stored in the storage part 211 of the information device 210, a user inputs print commands through an input part (not shown) provided on the information device 210. The application part 213 transmits the print commands input by the user to the chat server 230 through the network 220. The transceiver 215 transmits the printing file to the chat server 230 through the messenger.

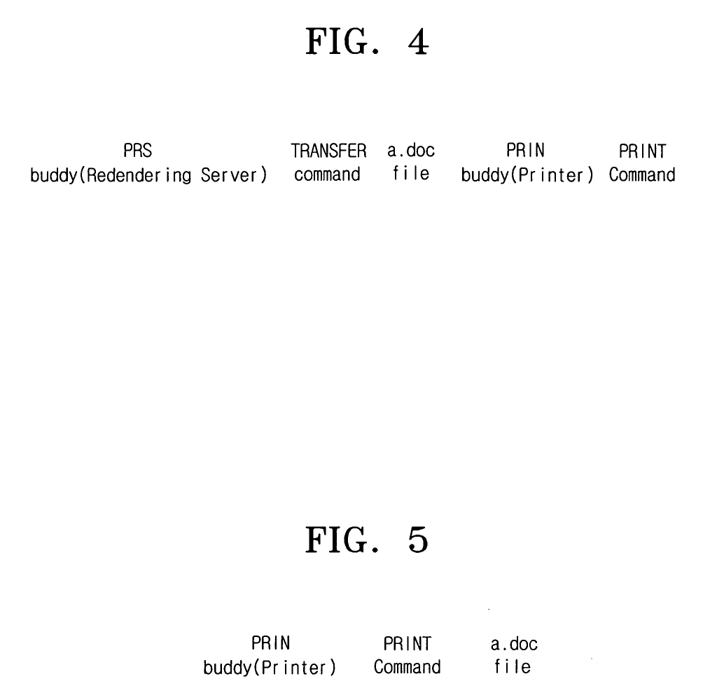

The command parser 231 of the chat server 230 analyzes the print commands executed by the information device 210 at step of S307, and according to a result of analyzing the print commands, the command executor 233 controls the conversion server 240 and the printer 250 at step of S309. That is, if the print command input by the user through the information device 210 is about a PDL file which will be converted by the conversion server 240 as shown in FIG. 4, the chat server 230 receives the printing file from the information device 210 and transmits the file to the conversion server 240 at step of S311, and the command executor 233 controls the conversion server 240 and the printer 250 to print the received file. The conversion server 240 receives the printing file from the chat server 230, and converts the received file into the PDL data. The printer 250 performs a print job with respect to the PDL data converted by the conversion server 240.

It is possible for a user to input direct print commands with respect to the printer 250, as shown in FIG. 5, through the information device 210. In this case, the chat server 230 receives the printing file from the information device 210 and transmits the file to the printer 250 directly at step of S311.

The printer 250 determines whether the file received from the chat server 230 is compatible with the printing operation of the printer 250 at step of S313.

If the file is not determined to be compatible with the printing operation, the chat server 230 transmits the printing file to the conversion server 240. Since the printer 250 has registered and stored the conversion server 240 linked through the network 220, the printer 250 can switch its connection to the conversion server 240 when the file is not determined to be compatible with the printing operation.

The conversion server 240 searches for an application compatible with the printing file which is received from the chat server 230 at step of S315. The application searched by the conversion server 240 is mutually interchangeable with the application for the printing file created by the messenger of the information device 210 or stored in the storage part 211. This application comprises Microsoft™ word, Hangul™ by Haansoft and the like.

When the search for the application with respect to the printing file is completed, the conversion server 240 converts the file into the PDL data to make it compatible with the searched application at step S317. The printer 250 prints the PDL data converted by the conversion server 240 at step of S319.

If the file received from the chat server 230 is determined to be compatible with the printing in the S313 step, the printer 250 directly prints the file received from the chat server 230 at step of S321.

As described above, since the information device 210 such as a laptop computer, a PDA or mobile phone, which has no printer driver installed therein, is capable of printing through the networked printer, the mobile terminal maximizes its source utilization.

Also, since the information device 210 such as a PDA or a mobile phone is allowed to print through the networked printer, the utilization of the network can be maximized.

The foregoing embodiment and advantages are merely exemplary and are not to be construed as limiting the present invention. The description of the embodiments of the present invention is intended to be illustrative, and not to limit the scope of the claims. Many alternatives, modifications, and variations should be apparent to those skilled in the art. In the claims, means-plus-function clauses are intended to cover the structures described herein as performing the recited function and not only structural equivalents but also equivalent structures.

1. A network printing system comprising:
an information device linked to a network, for transmitting and receiving messages with an external device through the network;
a chat server for providing a messenger to the information device to transmit and receive messages between the information device and the external device through the messenger; and
a printer linked to the network, for performing a print job with respect to a file which is requested for printing by the information device,
wherein the chat server receives the print-requested file from the information device through the messenger and transmits the file to the printer.

2. The network printing system as claimed in claim 1, further comprising a conversion server for converting the print-requested file into a Page Description Language (PDL) data,
wherein, if the print-requested file is not compatible with the printer, the printer prints the PDL data converted by the conversion server.

3. The network printing system as claimed in claim 2, wherein the information device comprises:
a transceiver;
an application part for driving the messenger provided from the chat server; and
a storage part for storing the print-requested file,
wherein the transceiver transmits the file stored in the storage unit to the chat server through the messenger driven by the application part.

4. The network printing system as claimed in claim 3, wherein the chat server comprises:
a command parser for analyzing a print command executed by the information device; and
a command executor for controlling the printer and the conversion part according to the print command analyzed by the command parser.

5. A network printing method comprising the steps of:
providing a messenger to an information device linked through a network via a chat server;
receiving a file requested printing by the information device through the messenger; and
printing the received file via a printer.

6. The network printing method as claimed in claim 5, further comprising the steps of:
determining an ability to print the received file via the printer; and
converting the file into a PDL data via a conversion server if the file is not determined to be compatible with the printer,
wherein the printer prints the PDL data converted by the converting step.

7. The network printing method as claimed in claim 6, further comprising the step of:
searching an application with respect to the file received through the conversion server,
wherein the converting step converts the file into the PDL data made compatible with the application searched by the searching step.

8. The network printing method as claimed in claim 7, further comprising the steps of:
storing the file for printing via the information device; and
driving the messenger provided from the chat server,
wherein the information device transmits the stored file to the chat server through the messenger.

9. The network printing method as claimed in claim 8, further comprising the steps of:
analyzing a print command executed by the information device via the chat server; and
controlling at least one of the printer and the conversion server according to the analyzed print command.
